(19) United States
(12) Patent Application Publication
(10) Pub. No.: US 2023/0105896 A1
(43) Pub. Date: Apr. 6, 2023

(54) COORDINATING A QUALITY OF SERVICE SETTING BETWEEN DIFFERENT CONNECTIONS

(71) Applicant: IPCOM GMBH & CO. KG, Pullach (DE)

(72) Inventors: Maik BIENAS, Schoeppenstedt (DE); Martin HANS, Bad Salzdetfurth (DE); Andreas SCHMIDT, Braunschweig (DE); Achim LUFT, Braunschweig (DE)

(73) Assignee: IPCOM GMBH & CO. KG, Pullach (DE)

(21) Appl. No.: 17/905,650

(22) PCT Filed: Mar. 9, 2021
(86) PCT No.: PCT/EP2021/055890

§ 371 Date: Sep. 6, 2022

(30) Foreign Application Priority Data
Mar. 11, 2020 (EP) 20162387.3

(51) Int. Cl. H04W 28/24; H04W 28/02

(52) U.S. Cl. CPC H04W 28/24; H04W 28/0268

(57) ABSTRACT

The present invention provides a method of controlling a first quality of service, QoS, parameter setting for a first connection between a first user equipment, UE, device and a first entity in a cellular communication system, the method comprising assigning the first QoS parameter setting for the first connection and adjusting the first QoS parameter setting for the first connection in response to a measurement of a QoS parameter for a second connection.

The present invention relates to the management of radio communication connections and in particular a quality of service (QoS) of the connections.

Known cellular mobile communication networks comprise a core network (CN), one or more radio access networks (RANs) and interworking functions to allow access from various other access networks like WLAN or fixed line networks, so called non-3GPP (N3GPP) access networks. The CN comprises amongst others functions for authentication and authorization of users and devices, for quality of service (QoS) management and control, for providing access to various data networks and for data routing between the RANs and data networks. The CN is typically radio access technology (RAT) agnostic, i.e. it comprises only functions that do not relate to a specific access technology or access network.

Each RAN comprises functions that provide to user equipment (UE) devices wireless radio access to the core network. Some of these functions are specific for the used RAT, e.g. UMTS, LTE or 5G New Radio (NR). A RAN consists of multiple macro base stations of a specific RAT (NB, eNB, gNB) and it may additionally comprise a number of small cell base stations (SCs) of the same or a different RAT. Fixed or wireless short-range network access to the CN is possible via interworking functions so that various types of access networks are supported by the CN. These access networks are commonly known as non-3GPP networks accessing the 5G CN via a non-3GPP interworking function (N3IWF).

UE devices that are registered in the CN may have a current connection to an access network and the CN, i.e. they are in connected mode, or they do not have such a connection, i.e. they are in idle or inactive mode. For UE devices accessing a CN via RAN in connected mode, there is typically one base station controlling the device, called serving base station or serving cell. This serving base station is using the radio resource control (RRC) protocol to establish an RRC context in both, the UE and the base station. The RRC context comprises the UE device's radio capabilities, the current setup of radio bearers (RBs) with respective radio protocol parameters, the multiplexing of services or applications on these radio bearers and the multiplexing of these radio bearers onto physical resources, the allocated usable resources and measurements to be performed by the UE device and triggering events and content for the reporting of such measurements.

UE devices accessing the CN via N3GPP access commonly do not have a connection control mechanism and a context that corresponds to the RRC connection or a radio bearer in cellular mobile access networks except for an IPSec security association between the UE device and a N3IWF of the CN. For most deployments of N3GPP access, a WLAN or DECT connection to an access point and via a fixed line (DSL, LAN, fibre) to an internet service provider are used. Most of the hops in these connections are based on best effort scheduling, some may also use IP-based quality of service mechanisms like differentiated services (Diffserv).

For data transfer in a mobile communication network, regardless of the access type used, UE devices have to establish a data connection into the CN, called a PDU session in 5G networks (and throughout this document) and an EPS bearer or PDP context in LTE and UMTS networks, respectively. The PDU session establishes a data connection from the UE device via a RAN or N3GPP network through one or more data routers of the CN, called user plane function (UPF) in 5G networks, to a destination data network (DN). The PDU session also establishes context information in network nodes that are involved in the establishment, maintenance and release of the PDU session. Some of these network nodes are:
The access and mobility function (AMF) to which the UE device is registered and that controls all signalling information exchange between the UE device and the CN. The AMF also involves other functions or nodes enrolled in the PDU session and provides respective information to these functions or receives information, e.g. to forward the information to the UE device. Usually only a single AMF serves a UE device.
The session management function (SMF) that controls the transfer and routing of data within the PDU session, i.e. it selects and controls the routers (UPFs) that transport the PDU session traffic. There may be multiple SMFs per UE device, but only one SMF for a single PDU session. The SMF may also allocate IP-addresses to the UE device for a PDU session.
The UPF routes and forwards data packets between access networks and the destination data network (DN) of the PDU session. They buffer packets for UE devices in idle mode and inform the AMF of downlink data pending to trigger a connection setup. The UPF handles and enforces QoS, i.e. it maps packets to service data flows (SDFs) within the PDP session and finally maps the SDFs to QoS flows to define a QoS applicable for the respective packets.
The policy control function (PCF) provides a unified policy framework to govern network behaviour. It provides policy rules to control plane functions such as AMF and SMF and it accesses subscriber data at the Unified Data Repository (UDR) for subscription information.
The network exposure function (NEF) is an interface between the operator network (PLMN) and external networks, e.g. 3rd party's servers and applications, so called application functions (AFs), for control data exchange. The NEF receives capabilities of UE devices and network functions of the PLMN, stores these and provides them to authorized entities within or outside the PLMN on request. The NEF also translates information between PLMN internal data and external data. Authenticated external application servers (AS) can request specific services from the CN via the NEF. They can request connections to mobile devices or request specific QoS for such connections.

The 5G CN has a QoS model based on QoS flows identified by a QoS flow identity (QFI). Data packets having the same QFI within a PDU session experience the same data forwarding treatment. The QFI is carried in transport layer headers of packets throughout their route through the CN. The SMF controls the QoS flows. For example, it provides packet detection rules to UPFs according to which the UPF can match an incoming packet to a QoS flow and thus add the appropriate QFI to the packet forwarding header. For UL data traffic, the UE device maps packets to a QFI according to QoS rules either configured by the CN during PDU session establishment, pre-configured earlier or implicitly derived by the UE devices.

A QoS flow has an associated QoS profile comprising the following (and other) parameters:
Whether the QoS flow is of guaranteed bitrate (GBR) or non-guaranteed bitrate (Non-GBR) and, for GBR flows, the guaranteed and the maximum flow bit rate.
Allocation and retention priority (ARP)
Aggregate maximum bitrate per PDU Session and per UE for all QoS flows and guaranteed and maximum flow bitrates for GBR QoS flows.
Maximum packet loss or packet error rate.
Packet delay budget (PDB), a maximum delay a data packet may suffer on its way from a UE device to the edge UPF or vice versa. For GBR bearers, packets that need more time to reach the edge of the network may be discarded and are counted in for the packet error rate determination. For Non-GBR bearers, the rules are not that strict. The actual packet delay comprises a part caused by delay between the access network and the edge UPF, i.e. the CN, and a part caused by delay in the AN, e.g. between UE device and base station. The target for the PDB is that 98% of packets arrive at the edge within the PDB constraint.

It is evident that the known QoS parameters set the target QoS for a bearer according to the service that is required or requested for data delivery between the two endpoints of the bearer. No parameters exist that set a target based on QoS provided to other services, to other bearers or to bearers of other subscribers.

Obviously, scheduling of different users or different bearers of the same or different users onto radio resources has an implicit QoS impact of one user or bearer onto another. That is, an inherent aim of radio resource scheduling is the solution of a situation in which multiple bearers or users compete for the resources. This effect does not provide QoS coordination between bearers or users using unrelated resources. While scheduling algorithms may be implemented to fairly distribute resources between users, the equal treatment of users or the reduction of QoS for one user to a maximum QoS level achievable for another user is not the aim of resource scheduling and thus not known from the prior-art.

3GPP TS 23.468 specifies a group communication system enabler for LTE. This feature enables group communication within a 3GPP network using LTE transport mechanisms. The principle architecture is based on a group communication server application server (GCS AS) which receives data from UE devices in uplink (UL) via a dedicated bearer and subsequently broadcasts the data to all other devices of the groups via a multimedia broadcast multicast service (MBMS) bearer or dedicated bearers. The MBMS bearer uses an MBMS that provides identical data to multiple users in broadcast fashion. The usage of dedicated bearers is intended in parallel to UE devices that are not efficiently reachable via MBMS.

QoS in group communication in LTE is based on two (or more) legs, the UL bearer delivering data from the source UE device to the GCS AS and the downlink (DL) MBMS or dedicated bearer or bearers. UL and DL are obviously aligned in terms of data rate or maximum error rate by an efficient implementation of a respective group communication system. However, there is no QoS coordination between different bearers of different users in the same direction or same destination.

U.S. Pat. No. 8,854,992 B2 describes a method for delay adjustment in continuous transmission control protocol (TCP) streams. The method comprises calculation of one or more statistical parameters associated with one or more groups of data packets within the continuous data stream, the statistical parameters being for example mean delay, a variance of delay, and a maximum delay of the continuous data stream. Then a delay target for transmission of the continuous stream is determined based on the calculated statistical parameters and prior to scheduling a second group of data packets an expected data delay for the second group of data packets is calculated. A comparison of the expected delay with the target delay leads to an increased or reduced data delay to a delay value that is within a present range of the delay target. Increasing and reducing the delay is done by delaying or expediting transmission of a received TCP ACK signal from a media access control (MAC) protocol layer to a TCP layer, respectively.

The statistical parameters based on which the delay of the data stream is adapted are generated over data packets of the same stream, i.e. an overall delay of packets of a single stream is steered towards a target delay without coordination of delay or other QoS parameters between different TCP connections of the same or different users.

The internet engineering task force (IETF) specifies in RFC 6824 “TCP Extensions for Multipath Operation with Multiple Addresses” the use of multiple paths for a single TCP connection. While in a simple form, the feature has a default path and switches to a second path only after the default path becomes unavailable, there are more sophisticated modes described. One of the modes allows routing of packets to either of multiple paths based on link costs which may be estimated based on link delay, link jitter or link stability of delay or bandwidth. A coordination of link parameters between different users of different TCP links is not described in RFC 6824.

The term bearer is used in cellular communication systems for a link between two network nodes of the system, e.g. a UE device and a base station or a UPF. The term will be used throughout this document as a general term for any kind of link or connection between two network nodes directly or via other (routing) nodes. A bearer may comprise one or more radio links or fixed network links like DSL, fiber-optics, local area network (LAN) or wireless LAN (WLAN or WiFi), some of the links may connect the same network nodes in parallel.

In the detailed description of the preferred embodiments the term PDP session is used in the same way as described above for the bearer, i.e. although a PDP session is meant in 5G system as a bearer between a UE device via a RAN to an edge UPF, it is used in this specification just as an example term for the general meaning of above term “bearer”.

Known communication systems, e.g. cellular communication systems, do not allow for a coordination of dynamic QoS parameter settings between different bearers of different users. Such legacy communication systems do not include dynamic coordination of one or more QoS parameters of a first user towards a QoS limit of a second user that would otherwise not apply to the first user. Also, dynamic enforcement of given QoS parameters of one bearer based on enforcement limits of another bearer is not known.

Dynamic is meant here as the coordination or enforcement of QoS parameters while the bearer is already set up and data transmission via the bearer already takes place. Dynamic is thus to be understood as opposed to a fixed configuration of QoS parameters at setup of a bearer.

US 2013/0136036 A1 describes a method for managing quality of service settings for group communications. A QoS setting is determined for each member and modifying the setting for one member based on a setting for another member. This document does not describe a measurement of a QoS parameter for a second connection.

WO 2016/091298 A1 describes a technique for determining a congestion level of a cell and updating flow-specific QoS policies based on information reported from a base station. EP 3 026 940 A1 describes a technique for managing a modification of QoS level when a user has two communication devices operating in two different networks.

The present invention provides a method of controlling a first quality of service, QoS, parameter setting for a first connection between a first user equipment, UE, device and a first entity in a cellular communication system, the method comprising assigning the first QoS parameter setting for the first connection and adjusting the first QoS parameter setting for the first connection in response to a measurement of a QoS parameter for a second connection.

In the present invention a QoS setting for one participant from two or more participants having similar or the same intentional QoS settings is aligned to an actual maximum (or minimum) achievable of another participant. The actual maximum achievable is a derivation of the actual QoS from the intended setting (which may be aligned between participants) and the intentional setting of one participant is modified to align it with the deviation from the settings another participant suffers.

The invention further provides a method of performing a connection setup in a mobile communication system for enabling multiple user equipment, UE, devices to communicate with each other, the method comprising receiving a request to set up a connection between the multiple UE devices including an indication of a desired quality of service, QoS, parameter setting for the connection for the multiple UE devices, establishing the connection with a first QoS parameter setting for each of the UE devices, and modifying the first QoS parameter setting to a second QoS parameter setting after a determination that a communication link to one of the UE devices is not capable of operating with the first QoS parameter setting.

In a first communication network the setup of a first bearer is requested, the request comprising at least one QoS parameter for which a maximum and/or minimum value is requested and a reference information. The reference information referring to one or more second bearers with the same or similar QoS parameters having the same or similar maximum or minimum value. The first bearer is setup by the communication network by configuring a UE device and a network node (UPF) with a bearer context comprising an initial setting of at least one QoS parameter with an initial target value.

Now, according to a first aspect of the invention, a measurement is performed on data transferred on the second bearer, the measurement providing a value of the at least one QoS parameter actually achieved. The value is then compared with the maximum and/or minimum value and in case the value exceeds the maximum value or is less than the minimum value, the target value of the QoS parameter of the first bearer is reconfigured to adapt QoS applied to the first bearer to the actual QoS limits measured for the second bearer. The relation of the bearers is determined by the network at least in parts based on the reference information.

A reconfiguration of the QoS parameter may include informing the UE device and/or the involved UPFs, e.g. by way of reconfiguration messages with updated QoS parameters sent to the device, the radio access network (RAN) or routing entities (UPF) in the CN.

The reconfiguration may alternatively be applied in enforcement of the QoS parameter in a subset of involved network entities, e.g. in a first UPF, without informing the UE device or other involved UPFs, e.g. throttling or delaying the first bearer in the first UPF.

The reconfiguration may only or in addition include a change of charging for the bearer provided by the network.

The first bearer may be a bearer set up between a first UE device and a first network node (UPF) or a first network edge node (UPF). The second bearer may be set up between a second UE device and the first UPF. Alternatively, the second bearer may be a bearer between the first UE device and second UPF.

In yet another alternative, the first bearer may be set up between a first UE device and a first UPF via a radio access bearer and one or more backhaul bearers and the second bearer may be set up between the first or a second UE device and the first UPF via a device-to-device link to a third UE device, a radio access bearer and one or more backhaul bearers.

In yet another alternative, the first bearer may be set up between a first UE device and a first UPF via a macro base station and the second bearer may be set up between the first or a second UE device and the first UPF via a small cell base station and the first or a second macro base station.

The request to set up the first bearer may originate from the first UE device, from a network node of the communication network (AF, NEF) or from an application server outside the communication network and received via a node of the communication network (AF, NEF).

The reference information contained in the request to set up a first bearer may reference a pre-defined group of UE devices to enable a QoS coordination between the group of UE devices. The reference information may in addition reference specific bearers or a specified bearer attribute to indicate specific bearers of the group of UE devices that are meant to have a coordinated QoS within the group of UE devices. The information additionally specifying specific bearers may specify a specific UPF as a common endpoint of the specific bearers or it may specify a common IP-tuple (IP-address, port number and transport protocol) to specify bearers. The reference information may alternatively specify a common target application server address for the data transmitted over the bearer or a common application using the specified bearer, i.e. a common IP port number.

The at least one QoS parameter may be the maximum delay or an average delay of data packets transmitted via the respective bearer and the measured value of the QoS parameter may be the actual delay of a single packet, an average delay of a group of packets or a maximum or minimum experienced delay of single packets of a group of packets. In that case, the delay target of the first bearer may be adapted or reconfigured in order to delay packets of the first bearer so that they experience a similar or the same average or maximum delay as packets of the second bearer, even though the network was capable of reaching a lower delay for packets of the first bearer. In the latter example, the increase of delay may be implemented in two alternative ways.

The first alternative is an enforcement of a higher delay of packets of the first bearer to equal its delay to the measured delay value of data packets of the second bearer. The use of introducing an additional delay may be to ensure equal conditions for a service that suffers from unequal transmission conditions, e.g. for gaming or for newly arising industrial applications as described later in relation to embodiments.

The second alternative is a relaxing of delay constraints for the first bearer as a result of the second bearer not being served with the original target delay value. The use of this alternative is for services that profit from low delay only if both the first and second bearer, or generally all bearers in a group of bearers, experience an equally low delay value. In that case, if any bearer cannot be served as targeted, the target for all other bearers can be relaxed to optimize the transmission costs.

The at least one QoS parameter may be a throughput, e.g. guaranteed, average, maximum or minimum data rate, and the measured value of the QoS parameter may be a current or average data rate. In that case, the data rate target of the first bearer may be adapted to the measured value of the second bearer if the measured data rate of the second bearer falls under or exceeds the target value by a pre-defined amount and/or for a pre-defined time. The adaption can again be in the form of a strict enforcement of the changed data rate or of relaxing of the required data rate for the first bearer, i.e. to save resources in the network. The use of limiting a bearer's required data rate to another bearer's measured throughput is for example for services that deliver the same or similar service to or from devices that have a basically same data rate and for which the overall service is limited to the lowest data rate of all served devices. As an example, a synchronized social media video delivery to multiple devices may ensure equal video quality on all devices. In case all but one device could be served with 8K video, but one can only be provided with data rate for 4K video, all devices are cut down to 4K by the network.

An alternative to downgrading QoS to the lowest of all bearers of a group of bearers is the downgrading only dependent on measurements of a sub-group of the group of bearers. A service may reference a single bearer of the group of bearers to provide the measured reference data rate and all other bearers are reconfigured to lower or higher data rate or delay only if the single bearer experiences the better or worse QoS. In order for this alternative to be implemented, a single bearer or user or a sub-group of bearers or users is pre-defined as privileged as part of the group definition.

Alternatively, the reference information provided in the request to set up the first bearer references the sub-group or the single bearer or user. This alternative could be useful if the referenced bearer serves a privileged user or device whose experienced service defines the maximum or minimum service for the group, e.g. because the privileged user is accounted for the service.

Preferred embodiments of the invention will now be described, by way of example only, with reference to the accompanying drawings in which:

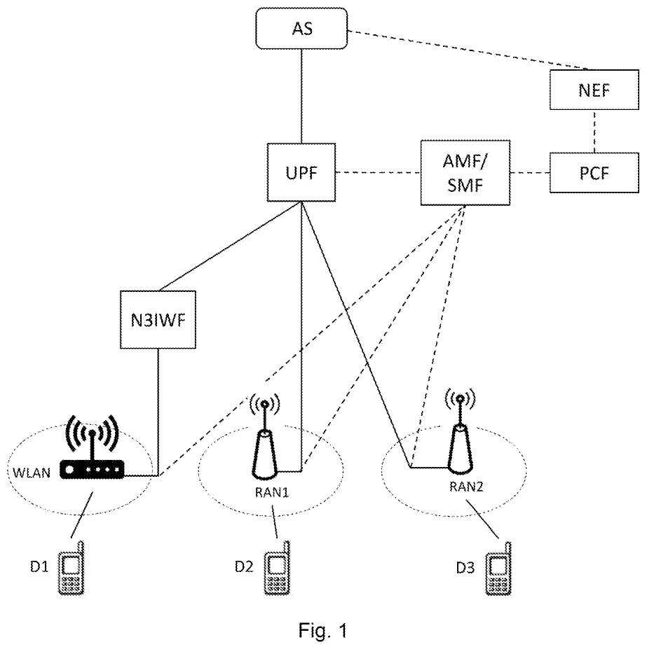

FIG. 1 is a schematic illustration of a connection established between multiple UE devices in a communication network;

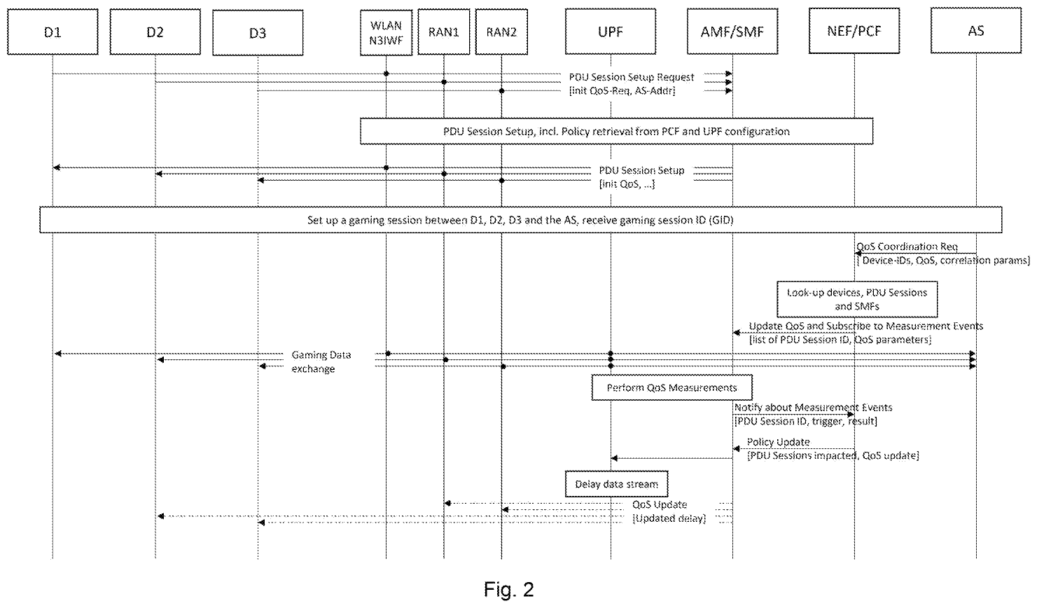

FIG. 2 is an exemplary message sequence chart for establishing the connection of FIG. 1;

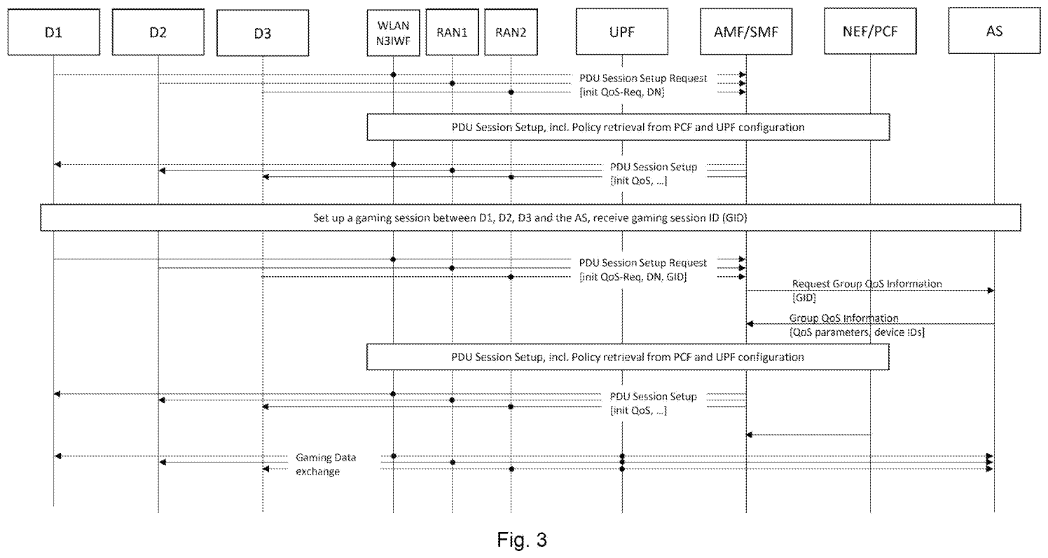

FIG. 3 is a further exemplary message sequence chart for establishing the connection of FIG. 1;

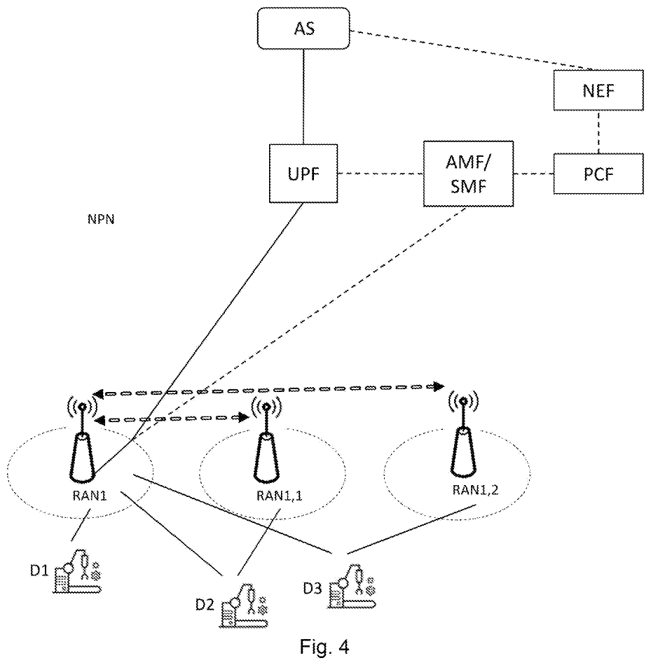

FIG. 4 is a schematic illustration of a further connection established between multiple UE devices in a communication network;

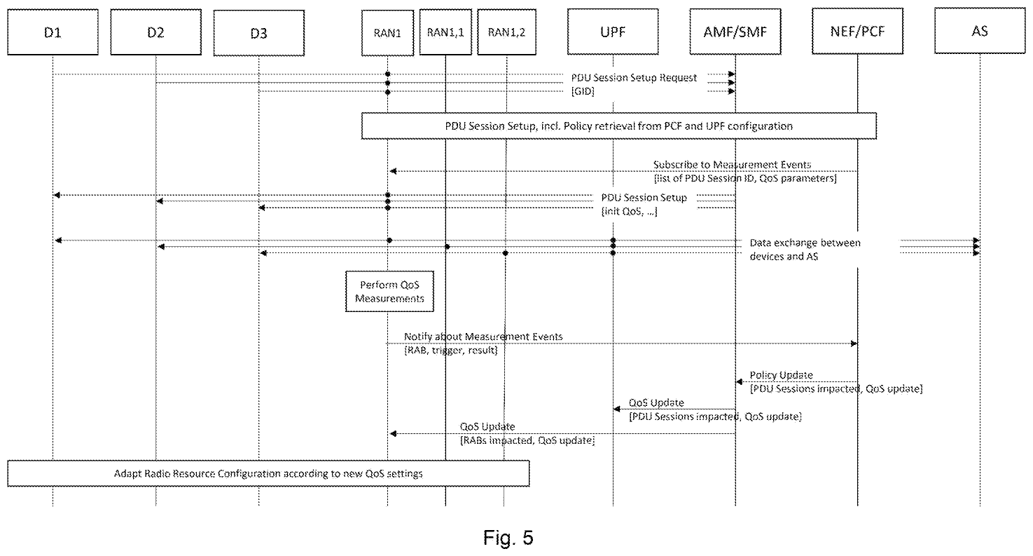

FIG. 5 is an exemplary message sequence chart for establishing the connection of FIG. 4;

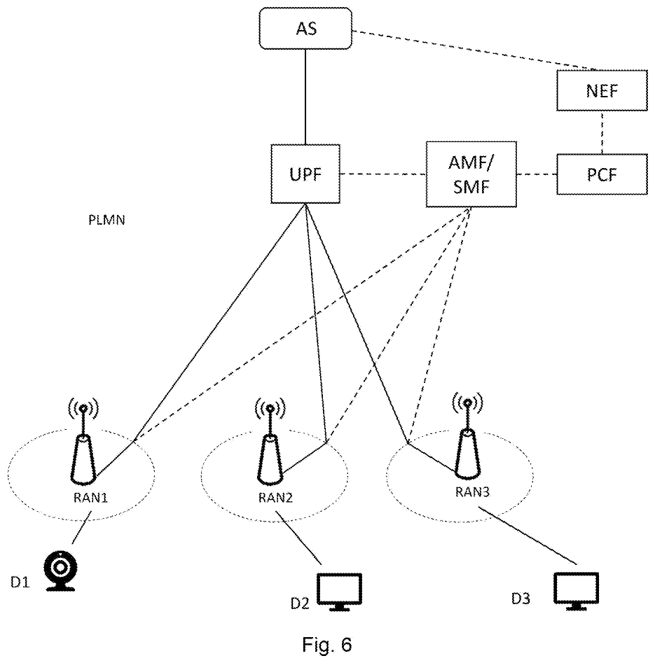

FIG. 6 is a schematic illustration of a still further connection established between multiple UE devices in a communication network; and

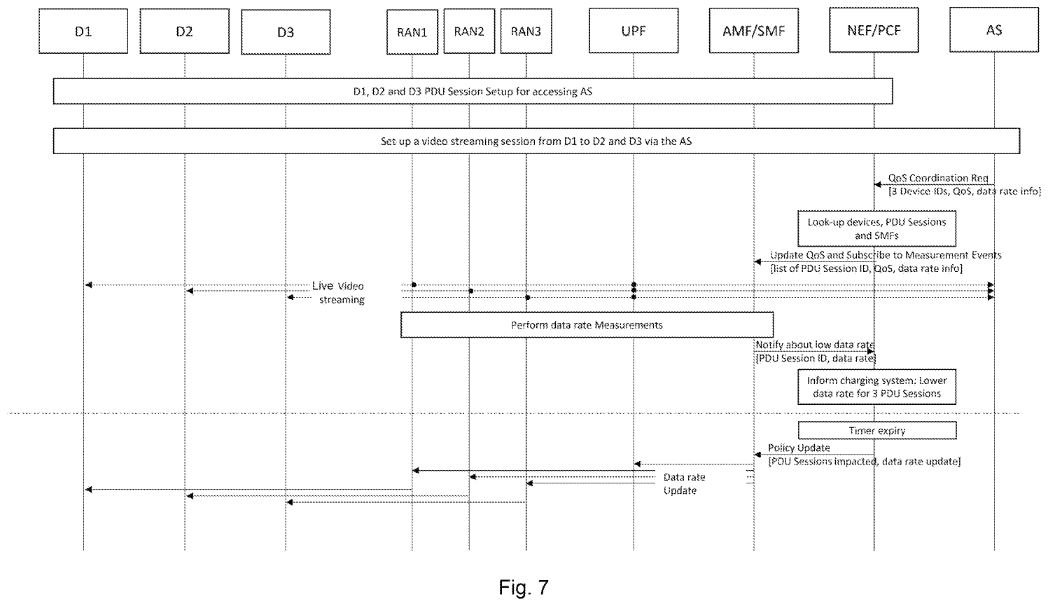

FIG. 7 is an exemplary message sequence chart for establishing the connection of FIG. 6;

In a first embodiment shown in FIG. 1, a group of users with respective mobile devices start a gaming session of a multi-player real-time game. To ensure good quality of experience for the players the service is set up with the minimum possible delay and to ensure fairness across the players, this invention keeps the difference of experienced delay amongst the players within pre-defined limits.

FIG. 1 shows in an exemplary manner three mobile devices (D1, D2, D3) that communicate with a core network (CN) of a mobile communication network. D1 communicates via an access point of a wireless local area network (WLAN) and public internet (not shown) with a non-3GPP interworking function (N3IWF) and further with an edge user plane function (UPF) of the CN. D2 communicates via a radio access network (RAN1) with the same edge user plane function (UPF) and D3 communicates via another radio access network (RAN2) with the edge user plane function (UPF).

The edge user plane function (UPF) is connected to a data network (not shown), e.g. the network of a gaming platform or the public internet. Within this data network, an application server (AS) provides gaming services to connected devices, e.g. mobile devices D1, D2 and D3.

In the CN, there are functions and entities controlling the registration of the mobile devices (AMF) and the setup and maintenance of PDU sessions (SMFs). Both are shown in one block in the figure for ease of readability. The AMF and SMF communicate with the mobile devices (shown as dashed line) via the respective access network (WLAN, RAN1 and RAN2). FIG. 1 shows only one AMF/SMF block while in real networks, there could be one serving AMF per mobile device and even multiple different SMFs for the different PDU sessions the respective mobile devices have set up. There could also be multiple UPFs for different connections to other data networks. Thus, FIG. 1 and all other figures of this specification should be interpreted as simplified sketches of networks that only contain sufficient details to give an understanding of the present invention without reflecting the full network functionality.

Also, in the CN, there are functions and entities supporting the AMFs and SMFs, e.g. to provide them with rules and policies for services and to adapt these rules and policies according to information received from the AS. This block is called NEF/PCF in the figure while in real networks the NEF and PCF are different entities that communicate with each other.

According to a first embodiment the users of mobile devices D1, D2 and D3 want to set up a gaming session triggered by a specific gaming application (App) running on the respective devices. When the App triggers PDU Session setup, it will request a QoS that is suitable for real-time gaming, e.g. very low latency and mid to high range data rate. The devices access their respective access network to connect to the AMF/SMF, register if not already done and request the setup of a PDU session to the data network (DN) of the gaming application server (AS) using an address (e.g. URL) of the AS, pre-defined in the gaming App.

Once the connection is setup, the mobile device will request from the AS the setup of a gaming session on application level, i.e. transparently to the network. Thereby, the application will request a gaming session identifying a specific group or session name. This group or session is the same for the sessions requested by devices D1, D2 and D3.

Now, according to this embodiment, the application server (AS) will request from the CN via the NEF the grouping of the connections established between the three mobile devices and the AS. The AS may provide to the NEF the IP addresses of the three mobile devices or another identification, e.g. the MSISDN, IMEI or any other identification provided by the mobile devices to the AS before or during the gaming session request or stored in the AS. The NEF will look up the identities provided in a subscriber data base of the CN and thus identify the mobile devices. It will further look up the responsible entity or entities in the CN that are responsible for management, control or enforcement of the QoS, e.g. the PCF(s), AMF(s) or SMF(s) and inform these about the grouping of the PDU Sessions. In contrast to FIG. 1, these entities can be different entities for the three UE devices.

The AS will provide together with the grouping request one or more QoS parameters and requested correlation of the parameters. In the present embodiment, the mobile devices may have requested PDU Sessions with a maximum delay (packet delay budget) of 30 ms from mobile device to the edge UPF (or vice versa). According to this invention the AS may request an average delay for each mobile device in the group that is within a range of +0 ms and −20 ms from the maximum delay any device of the group experiences. In addition, the AS may request the coordination of this range up to a certain maximum, e.g. 80 ms, and it may request strict enforcement of average delay. In other words, the AS requests an enforcement of delay so that initially an average delay of 30 ms is installed and no mobile device of the group experiences a delay lower than the maximum delay experienced by any other device of the group minus 20 ms.

This delay should be strictly enforced, i.e. packets that would otherwise experience lower delay will be buffered for a respective time in a network entity. For example, if any device suffers an average delay of 60 ms although 30 ms were initially requested, maybe due to congestion on the WLAN connection of device D1, the other devices will be delayed by the network so that their delay is within the range of 40 ms to 60 ms. If, for some reason, the maximum average delay increases for any mobile device of the group beyond 80 ms, the average delay of the other devices in the group will be enforced to a range not exceeding 60 ms to 80 ms, e.g. in order to keep the delay at a level suitable for playing at all. If, at a point in time, a device with high delay drops out of the group, e.g. by releasing its connection, the delay of the rest of the group will be re-aligned to the best possible value within the range negotiated with the AS. As well, if the device whose measurement that triggered the alignment receives a better delay later, a re-alignment back to lower or no introduced delay for the other devices will be performed.

There are many different ways to implement the present invention internally in the network. One example is described in the following without losing generality. The NEF will provide the requested grouping and correlation information to the PCF. The PCF will translate the mobile device identifications provided by the AS via the AMF/SMF into identifications of PDU sessions to be correlated. This may be done based on PDU Session information stored in the PCF or respective information requested from a data base in the CN or the responsible AMF.

The PCF will then subscribe, e.g. at the responsible SMFs, to regular measurements of average delay of the respective PDU sessions. Based on such measurements received, the PCF will determine whether the average delay of a PDU session is out of the requested range and requires adjustment. If so, the PCF will request from the respective SMFs to adjust the settings of the impacted PDU sessions. The SMF will request from a user plane functions of the PDU sessions to introduce a certain delay into the data flow. It is thus ensured that no mobile device of the group experiences a delay lower than 20 ms under the maximum delay experienced in the group.

In an alternative implementation of the first embodiment, a specific one of the three UE devices building the group of UE devices, e.g. UE device D1, is the single source of reference delay. It may be that the subscriber of UE device D1 is in control of the group, e.g. he is billed for the group related services, or his device defines the reference delay for some other reason. In this case and in relation to the first embodiment, the PCF will subscribe only to regular delay measurements of UE device Dl at the respective SMF and the PCF will build its decision to adapt the other UE device's QoS on these measurements only.

The subscription of the PCF to delay measurements can be on a regular basis, i.e. periodical measurements or whenever the UPF or SMF performs such measurements. The subscription can also provide the thresholds to the UPF or SMF so that measurement reports in notification messages are only generated in case the threshold is exceeded or undergone.

FIG. 2 depicts a message sequence chart showing the entities of FIG. 1 and the messages exchanged between the entities according to the first embodiment of this invention. It is assumed as a prerequisite, that devices D1, D2 and D3 are registered and connected to the mobile network. On the devices, a gaming app is started, and the app triggers the devices to setup a connection to a gaming application server AS. The triggering is not shown in FIG. 2. The devices each request a PDU session setup at their respective AMF via their respective access network WLAN and N3IWF, RAN1 and RAN2, respectively, indicated as a solid dot where the arrow representing the message and the line representing the network entities cross.

The CN performs the PDU session setup involving PCF, UPF, data bases of the network (not shown), allocating an IP-address for the connection to the AS, potentially selecting an appropriate data network (DN, not shown) of the AS and other procedures. Especially a QoS including a guaranteed or non-guaranteed bitrate, PDB and priority is selected based on the QoS requested by the devices, the subscribed-to QoS retrieved from a data base (not shown) and the current network situation from the PCF. The CN will finally setup the PDU sessions by sending to each device a PDU session setup message with the QoS parameters which are only initial QoS parameters as they will get changed throughout the procedure.

Now, the devices are enabled to connect to the AS. According to the first embodiment, the gaming app on the devices establishes a gaming session with the AS, thereby also generating a gaming session identification (GID). According to the current invention and the example of the first embodiment, the AS requests QoS coordination from the NEF providing to the NEF an identification of the devices between which the coordination of QoS is sought. The AS also provides initial QoS, e.g. including an initial PDB of 30 ms, and information about what QoS parameters need to be coordinated, e.g. the overall packet delay, and what kind of coordination is requested, e.g. strict enforcement between 0 and 80 ms with a maximum deviation of 20 ms between devices. The device identification may be provided as individual device addresses, e.g. IP-addresses, or in form of the GID in case the GID is pre-defined or otherwise known to the CN.

The NEF looks up the PCF responsible for the devices (if multiple PCFs are present in the PLMN) and informs the PCF about the requested QoS coordination. The PCF will look up the affected PDU sessions and responsible AMFs and SMFs and inform about the updated QoS for the PDU sessions and subscribe to measurement events related to these PDU sessions. While the gaming session is running and data is exchanged between the devices and the AS, measurements are performed, and measurement data is received in the SMF. The measurements can be performed in any network entity that is part of the data delivery, i.e. the RAN or UPFs or even the UE itself. The measurements and delivery of measurement data is not shown in FIG. 2, but the current embodiment assumes the measurement data to be present in the SMF. The SMF notifies network elements subscribed to the respective measurement events, i.e. the PCF. If the measurement data shows a delay for one PDU session to exceed the currently defined range for all PDU sessions in the group received from the AS, the PCF will change policy setting for the respective PDU sessions and inform the respective SMFs about a change of QoS parameters. The SMF will inform the respective entities, in this example the UPF, but as mentioned above, this could also be the RAN or the devices.

As a result, the UPF will strictly enforce the new QoS parameters, i.e. it will delay packets of PDU sessions that still have low packet delay to equal their average delay to the PDU session(s) that have been measured to be delayed. In addition, the SMF may optionally inform other entities, e.g the RAN and/or the devices about the QoS change. If these devices are involved in enforcing the QoS, they will be informed, otherwise the information may be optionally provided by the SMF.

Note again, that the PCF and SMF is just an example of entities to manage the QoS coordination of this invention. Other entities like the AMF, NEF, RAN and UE may perform the full or parts of the functionality described herein.

In a second embodiment having a similar network as the first embodiment according to FIG. 1, again the three mobile devices D1, D2 and D3 want to establish a gaming session with the application server AS. In contrast to the first embodiment, in the second embodiment the mobile devices provide the grouping information to the network. They include, when requesting setup of the respective PDU sessions, a group identification information and QoS parameter correlation into the PDU session setup request. This may cause the AMF and/or SMF to provide the information to the PCF which uses that information in a similar way as in the first embodiment. Alternatively, the SMF itself enforces the QoS parameter correlation by processing received QoS measurement data from user plane functions UPF and determining necessary adjustments in QoS parameters of specific PDU sessions. The adjustments are then communicated to respective user plane functions to introduce or adapt the required delay.

The group identification in the second embodiment needs to be known to the mobile device before it can be included in the PDU session setup request. The group identification may be received from the application server (AS) which may have provided that information to or received it from the CN, e.g. via the NEF, before the session setup started. Each mobile device may for example provide in the PDU session setup request a group identification that is stored in a data base of the CN together with the IP addresses of respective mobile devices. The AMF, SMF or PCF can then look up the group identification in a data base of the CN and translate it into subscriber and bearer information needed to coordinate QoS between the respective bearers.

In a preferred alternative to the second embodiment, the devices each provide the same group identification (GID) within their PDU session setup request together with an indication that the GID is for installing coordinated QoS for the PDU sessions. The CN then requests the AS to provide detailed information related to the group, i.e. the AS may receive the GID from the CN via the NEF and provide back the to-be coordinated QoS parameter and its values and also the devices that are part of the group.

The actual bearer QoS coordination in the second embodiment is very similar or the same as for the first embodiment and thus omitted from this description.

Similar to the first embodiment, an alternative implementation of the second embodiment could base QoS adaptions only on the delay of a single of the devices, e.g. mobile device D1, and the other mobile device, D2 and D3, would indicate in the PDU session setup request a reference to UE device D1, e.g. its MSISDN, its IP-address or an application layer address that is known to the CN. Alternatively, the other mobile device would indicate a group identification GID that is known in the AS or the CN as representing a group of devices one of which is defined to provide the delay reference for the other group members.

FIG. 3 depicts a message sequence chart for the second embodiment having the same architecture as shown in FIG. 1. The devices D1, D2 and D3 request a PDU session setup from their respective AMF and SMF. They provide in the request initial QoS requirements suitable for communicating with the AS and a data network (DN) name as the target network of the PDU session instead of the AS-address of the first embodiment. Providing the DN is just an alternative in signalling and does not have relevance with respect to the current invention. The CN prepares the PDU sessions and replies to each device with a PDU session setup message. Now, the devices can communicate with the AS and establish via the respective gaming app a gaming session, receiving a gaming session identification (GID).

For the actual gaming data transfer in this embodiment, the devices request setup of additional PDU sessions with initial QoS suitable for gaming, i.e. low latency and mid to high data rate, and the DN name. Also, the devices provide the GID to indicate a coordinated QoS is requested. According to this invention, the SMF requests from the AS via the NEF detailed information of the session. In order for the SMF to identify the AS, the GID may have a form comprising an AS identity, e.g. “session345.multiplayergames.somegame.com” where the AS is reachable under the URL multiplayergames.somegame.com. In order for the communication between the CN and the AS, both are assumed to have a service level agreement (SLA) and requesting QoS information from the AS may follow a CN-internal look up of SLA data from the CN data bases to receive agreed QoS ranges or devices that are suitable (not shown).

The AS provides to the CN information about QoS parameters to be coordinated and the respective range settings. Optionally, the AS provides identifications of the devices that are part of the group, e.g. in form of the current IP-addresses, to ensure the correct devices participate in the QoS coordination. After having received the QoS information from the AS, the CN will prepare the PDU sessions, reply to the devices with a PDU session setup message and thus the gaming session can start. Enforcement of the coordinated PDU session in this second embodiment is similar as in the first embodiment and therefore omitted from FIG. 3.

A third embodiment may for example be implemented in an industry plant having its own communication infrastructure, e.g. a 5G mobile communication network that is a non-public network (NPN) in contrast to a PLMN. This embodiment is based on a setup according to FIG. 4. The figure shows a CN, example wise with AMF/SMF, UPF, PCF and NEF and three base stations (RAN1, RAN1,1 and RAN1,2). RAN1 has a macro base station with a fixed line connection to an AMF of the CN. RAN1,1 and RAN1,2 are small cell base stations with a wireless backhaul, indicated in the figure as a dotted double-lined arrow.

The mobile devices D1, D2 and D3 are in this embodiment industrial machines interconnected via the non-public network (NPN). The mobile devices D1, D2 and D3 are all connected to base station RANI. D2 and D3 are in addition connected to RAN1.1 and RAN1.2, respectively, which are small cell base stations and have the role of secondary base stations for the two devices. The small cell base stations are connected to the macro base station RANI via a respective wireless backhaul link.

Now assuming the three machines D1, D2 and D3 are all working together in a process whose speed of execution strongly depends on a synchronization of movement and sensor data exchanged between the machines. The devices will connect to the CN and request connection between each other and/or to an application server (AS) that is present near-by, i.e. on the industrial plant area, with the shortest possible delay.

Assuming that an NPN has rather limited resources, serving devices with the shortest possible delay may be extremely expensive, e.g. because resources may be permanently allocated to the devices to keep signalling delays low.

According to the current invention, the devices build a group of devices that may be pre-defined in the AS and group information is provided to the CN or the group is pre-defined directly in the respective data bases of the CN. The mobile devices, that is, the cellular mobile communication modules within or attached to the assumed industrial machines, will request setup of PDU sessions and will provide a group reference for coordinating the delay between these devices. The PDU session setup request may further include an initial maximum delay or PDB requested and an indication that the coordination of delay is for relaxing the delay constraints and not for a strict enforcement, i.e. in case of unequal packet delay throughout the group, packets do not need to be buffered in order to increase their delay, but delay requirements can be relaxed if the requested low delay cannot be achieved throughout the group. Alternatively, and this is the preferred implementation of the third embodiment, the group as well as the QoS settings including the necessity for QoS coordination is stored in the CN, e.g. in a device or subscriber data base of the CN (not shown in any figure). This is a realistic assumption as NPNs are small and local networks that may be administered by companies for a single industrial plant. Administering a device data base with individual QoS settings and group definitions can well be maintained for NPNs in contrast to PLMNs with millions of subscribers and regularly changing devices. In this case, the devices will omit QoS information in their PDU session setup request all together and only provide a group ID (GID) for lookup of the information in the CN.

The CN will use this information to setup respective PDU sessions for each of the three devices with an initial QoS including an initial PDB that is very low, i.e. 20 ms. This embodiment assumes D3 uses RAN1,2 and D2 uses RAN1,1 for user data exchange, while both devices use RANI for control data exchange, and in an initial state of the data communication, the wireless backhaul for both small cell base stations is setup with low delay so that the requested PDB can be kept. At a later point in time, the wireless backhaul connection of RAN1,2 gets worse and delay on that connection increases. Thus, measurements in the RAN or the CN will reveal shortly after, that the envisage PDB cannot be kept for packets from and to device D3.

As the PCF is subscribed to these delay measurements, it is informed about the deviation of delay for device D3. The PCF, aware of the group of devices and of the coordinated delay, derives a relaxed delay constraint for those PDU sessions of devices D1 and D2 that interconnect the devices with D3. The PCF informs the SMFs controlling the respective PDU sessions of D1 and D2. The SMFs may then take actions based in the new and relaxed delay requirements of the devices:
The SMF may change the QoS parameters of the PDU sessions of D1 and D2 that interconnect the devices with D3 and inform the UPF and/or the devices to switch routing of packets from these PDU sessions to a different QoS flow with higher, i.e. more relaxed delay parameters. The changed parameters may then impact the radio bearers set up by RAN1 and RAN1,1 to reflect the relaxed parameters.
The SMF may change the QoS parameters of the PDU sessions and it may inform the UPF and/or the devices to change the delay parameters of the QoS flow used for the PDU sessions, e.g. to relax the delay constraints or increase the PDB. Again, the changed parameters may then impact the radio bearers set up by RAN1 and RAN1,1 to reflect the relaxed parameters.
The SMF may also keep the parameters unchanged as the relaxing of the parameters does not necessarily require changes to the parameter setup. The SMF or in general the CN may only change the current configuration of a PDU session if the total QoS deviation exceeds a certain threshold or if the radio resource situation of the NPN shows that resources are currently scares.
Just for completeness it can be mentioned that the CN or the RAN may certainly also take measures to improve the QoS situation for D3 and overcome the high delay the device is suffering, but this is well known radio resource management and device configuration that is not subject of the current invention.

FIG. 5 is a message sequence chart for the third embodiment. It shows the devices D1, D2 and D3, now being industrial machines, to request PDU sessions to communicate with each other for sensor and motion synchronization via an application server (AS). The PDU session setup request comprises a group identification GID that is pre-defined in the CN. Thus, the CN can prepare the PDU sessions including setting up the QoS coordination in the PCF. The PCF will then subscribe at the serving primary base station (RAN1) for appropriate delay measurement events. The subscription can alternatively (not shown) also be at the UPF or SMF, as mentioned before and as valid for all embodiments of the present invention. A PDU session setup message will provide initial QoS setting to the devices and data exchange can begin.

Assuming after a while the wireless backhaul delay of RAN1,2 increases and RANI detects the change and notifies the PCF about the new delay measurement. The PCF may then decide to relax the QoS constraints on the PDU sessions not directly impacted to reduce network costs. The relaxed QoS parameters are provided to the responsible SMFs which will inform RANI and the UPF. Now, RANI can adapt the radio resource configuration of all involved base stations (RAN1, RAN1,1 and RAN1,2 and the UE) in order to safe resources. It may be beneficial to not change the target delay for device D3 to be able to detect in RAN1 when the delay is again within the limits of the original delay settings and the PCF is informed to adapt the QoS settings back to their original short delay.

A fourth embodiment relates to a setup according to FIG. 6 in which a network is set up similarly to FIG. 1 and the first embodiment. Three devices D1, D2 and D3 access the network through base stations RAN1, RAN2 and RAN3, respectively. D1 is a camera, e.g. a web cam taking a live stream of an event or a location, or multiple cameras or any other video data source. Device D1 transmits the respective video data to an application server AS. The AS streams the video data to devices D2 and D3, which are video data sinks, e.g. devices equipped with a display on which a user can watch the video stream or streams. The embodiment assumes the devices build an explicit group, i.e. the video stream is not publicly broadcasted but distributed only in the distinct and pre-defined group.

According to this invention, the devices request setup of a PDU session to the application server AS which provides the service of video data distribution. Devices D2 and D3 subscribe at the AS to the video data from device D1 and the AS informs the CN, e.g. via the NEF about the group of devices and the required coordinated QoS. Coordination in this embodiment relates to coordinated data rate. Assuming the video service to generally offer 8K video distribution, the AS may request a guaranteed bitrate of 80 Mbps for UL video data of device D1 and 80 Mbps for the two DL unicast video streams to devices D2 and D3. As this service is expensive, the AS requests from the CN to coordinate the QoS between the devices and references the UL transmission data rate of device D1, as the reference QoS for DL transmission data rate of devices D2 and D3. The coordination is example wise again assumed to be performed in the PCF that receives the reference information from the AS via the NEF and links the references to the respective PDU sessions. Also, the PCF subscribes to data rate measurements at the respective UPF, SMF or RAN as a trigger for potential future QoS parameter changes of the PDU sessions.

According to this invention, if at any point in time, the achievable data rate of device D1 drops below the guaranteed value of 80 Mbps, e.g. to 40 Mbps, the guaranteed data rate for device D2 and D3 will be adapted and respective charging for the data rate will be reduced. D1 will then potentially change its video codec to generate lower bit rate video data. If at any later point in time the achievable data rate of device D1 increases back to its requested value, the guaranteed data rate of devices D2 and D3 is also increased.

The achievable bit rate may be measured by any of the routers of the network, e.g. a UPF, or it may be reported by the RAN, e.g. by base station RAN1, as a result of radio resources available and required transmission configuration for device D1. In the latter case, the PCF may alternatively subscribe to radio configuration changes or data rate changes at the RAN. In yet another alternative, the UE may report configuration changes resulting in achievable data rate changes to the CN, e.g. via AMF to the SMF, and the PCF subscribes at that entity to be informed accordingly.

The data rate measurement or reporting alternatives described in the fourth embodiment are also applicable as alternatives to the first three embodiments. As well, the request for coordinated QoS that is introduced in the invention, can in all embodiments come from the mobile devices as in the second and third embodiments or the application server AS as in the first and fourth embodiment. In fact, any other entity like a RAN or CN entity may requested coordinated QoS over multiple PDU sessions according to this invention.

A further alternative deployment option that may be applied to all before mentioned embodiments is to limit the impact of QoS coordination on the charging system, i.e. if a QoS parameter of a PDU session whose QoS is coordinated with other PDU sessions cannot be met, the charging of other PDU sessions is adapted without changing their actual QoS settings. This would allow the charging to be based on the least QoS of a group of PDU sessions while the actual QoS settings would be unchanged, e.g. in order to keep the necessary signalling in the CN low. This further alternative could be applied for a certain time before the QoS parameters are actually changed, e.g. after a time expired.

FIG. 7 shows a message sequence chart for the fourth embodiment. In a first step, the three devices D1, D2 and D3, request PDU session setup to enable them to connect to the AS and establish a video streaming service. The request, preparation and response for each individual device are shown in a single box in FIG. 7 as they are very similar to any of the former embodiments.

The devices will then contact the AS and setup a streaming session with D1 as a video source and D2 and D3 as video sinks. The AS informs the CN via NEF about the required QoS coordination including the requested data rate of 80 Mbps and the requested coordination of the data rate with the UL data rate of device D1 as reference for adapting the DL data rate of devices D2 and D3.

The NEF and PCF look up the impacted PDU sessions and responsible network elements (SMFs) and updates the QoS including a guaranteed bitrate of 80 Mbps. The live video streaming is assumed to start. The respective network element will regularly perform data rate measurements for the respective PDU session of device D1.

According to this embodiment, it is assumed that at some point in time the UL data rate of the PDU session used for video UL streaming by device D1 cannot be held, e.g. by RAN1 because of missing radio resources or because the link between D1 and RAN1 worsened. RAN1, AMF or SMF inform the PCF about the currently reduced data rate.

Now, according to this invention, the PCF informs the charging system about a change in accountable data rate for the video streaming PDU sessions of devices D1, D2 and D3. Thus, the accounting for the service is reduced to reflect the respective changes. A change in the actual QoS parameters for the PDU sessions is optional (indicated in FIG. 7 by a horizontal dashed line).

It is assumed that in order to save signalling load on the CN, a timer is started when the notification of the data rate measurement is received. Only when the timer expires and the data rate has still not increased back to the original value, the PCF informs the SMFs and/or AMFs about the policy change regarding the PDU sessions while the information to the charging system was provided immediately after the data rate notification was received. The AMFs and/or SMFs can then change the QoS setting of respective UPFs and RAN entities (RAN1, RAN2 and RAN3). The RAN entities can, as a result, change radio resources or radio protocol parameters of devices (D1, D2 and/or D3).

1. A method of controlling a first quality of service, QoS, parameter setting for a first connection between a first user equipment, UE, device and a first entity in a cellular communication system, the method comprising assigning the first QoS parameter setting for the first connection and adjusting the first QoS parameter setting for the first connection in response to a measurement of a QoS parameter for a second connection.

2. The method according to claim 1, wherein the second connection is a connection between a second UE device and the first entity, a connection between a second UE device and a second communication network entity or a connection between the first UE device and the second communication network entity.

3. The method according to claim 1, wherein the first connection comprises a first radio link and the second connection comprises a second radio link and wherein the first radio link uses radio resources that are independent of radio resources used by the second radio link.

4. The method according claim 1, wherein the first QoS parameter setting is adjusted by sending a reconfiguration message to the first UE device.

5. The method according to claim 1, wherein the first QoS parameter setting is adjusted by updating a setting in one or more communication network entities.

6. The method according to claim 1, wherein a request to establish the first connection includes a reference to a pre-defined group of one or more further UE devices and the second connection is a connection to a UE device which is a member of the pre-defined group.

7. The method according to claim 6, wherein a coordination of QoS parameter settings is performed between the members of the pre-defined group.

8. The method according to claim 1, wherein the first QoS parameter setting includes at least one of a maximum packet delay parameter, a target average packet delay parameter, a maximum allowable data throughput rate, and a minimum guaranteed data throughput rate parameter.

9. The method according to claim 1, wherein the first entity is one of a base station, a user plane function and a data network.

10. The method according to claim 1, wherein a second QoS parameter setting is assigned to the second connection and the adjusting the first QoS parameter setting for the first connection is performed in response to a determination that at least one value of the measurement of a QoS parameter for the second connection is not within allowable bounds of the second QoS parameter setting.

11. The method according to claim 10, wherein the first and second QoS parameter settings comprise identical parameter settings.

12. The method according to claim 9, wherein the adjusting the first QoS parameter setting for the first connection comprises increasing at least one of the maximum packet delay and the average packet delay in response to determining that the respective delay measurement of the second connection is higher than set by the second QoS parameter settings.

13. The method according to claim 9, wherein the adjusting the first QoS parameter setting for the first connection comprises decreasing at least the data throughput rate in response to determining that the data throughput rate measurement of the second connection is lower than set by the second QoS parameter settings.

14. The method according to claim 1, wherein the adjusting the first QoS parameter setting for the first connection comprises introducing delaying data packets of the first connection in a network entity in response to determining that at least one of a maximum packet delay measurement and an average packet delay measurement for the second connection is higher than a respective setting in a second QoS parameter setting of the second connection.

15. A method of performing a connection setup in a mobile communication system for enabling multiple user equipment, UE, devices to communicate with each other, the method comprising:
receiving a request to set up a connection between the multiple UE devices including an indication of a desired quality of service, QoS, parameter setting for the connection for the multiple UE devices,
establishing the connection with a first QoS parameter setting for each of the UE devices, and
modifying the first QoS parameter setting to a second QoS parameter setting after a determination that a communication link to one of the UE devices is not capable of operating with the first QoS parameter setting.

16. A mobile communication system including a controlling entity for controlling connections of multiple user equipment, UE, devices, in the mobile communication system, the controlling entity comprising:
a receiving device for receiving a request to set up a connection between a plurality of UE devices, the request including an indication of a desired quality of service, QoS, parameter setting for the connection,
a connection setup device for establishing the connection with a first QoS parameter setting for each of the plurality of UE devices,
a QoS monitoring device for receiving measurements of a communication link to one of the plurality of UE devices, and
a QoS controlling device for modifying the first QoS parameter setting to a second QoS parameter setting in response to the QoS monitoring device determining that a connection to one of the plurality of UE devices is not capable of operating with the first QoS parameter setting.

17. The method according to claim 2, wherein the first connection comprises a first radio link and the second connection comprises a second radio link and wherein the first radio link uses radio resources that are independent of radio resources used by the second radio link.

18. The method according to claim 10, wherein the adjusting the first QoS parameter setting for the first connection comprises increasing at least one of the maximum packet delay and the average packet delay in response to determining that the respective delay measurement of the second connection is higher than set by the second QoS parameter settings.

19. The method according to claim 10, wherein the adjusting the first QoS parameter setting for the first connection comprises decreasing at least the data throughput rate in response to determining that the data throughput rate measurement of the second connection is lower than set by the second QoS parameter settings.
